(19) United States
(12) Patent Application Publication
(10) Pub. No.: US 2026/0328627 A1
(43) Pub. Date: Oct. 22, 2026

(54) SYSTEM AND METHOD USING MACHINE LEARNING TO PREDICT A FLUID TEMPERATURE WITHIN AN ELECTRIC PUMP

(71) Applicant: Hanon Systems EFP CANADA LTD, Concord (CA)

(72) Inventors: Harpreet Singh, Concord (CA); Raunaq Kainth, Concord (CA); Yash Kundlass, Concord (CA); Matthew Williamson, Concord (CA)

(21) Appl. No.: 19/181,983

(22) Filed: Apr. 17, 2025

(51) Int. Cl. G01K 7/42; G01K 13/02; G06N 20/00

(52) U.S. Cl. CPC G01K 7/427; G01K 13/02; G06N 20/00

(57) ABSTRACT

Systems and methods are disclosed that use machine learning to predict a temperature of a fluid within an electric pump. The system comprises a computing system including one or more processing devices in communication with one or more sensors via at least one communication network. The one or more sensors are isolated from the fluid within the electric pump and configured to detect and/or measure one or more parameters associated with the electric pump. Upon execution of the computer-readable instructions, the computing system is configured to: receive, via the at least one communication network, input data comprising the one or more parameters detected and/or measured by the one or more sensors, and predict, via the at least one processing device, the temperature of the fluid within the electric pump using the input data and machine learning.

### FIELD

This invention relates generally to the field of electric pumps, and more particularly to systems and methods using machine learning to predict a fluid temperature within an electric pump.

### BACKGROUND

Electric pumps play a critical role in ensuring a smooth operation of electric or hybrid vehicle transmissions, hydraulic systems, and other essential automotive systems. These pumps circulate oil or other fluids to lubricate gears, reduce friction, and maintain proper operating temperatures. To ensure an efficient operation and longevity of these pumps, sensors are integrated into the system to monitor various parameters.

In particularly, electric transmission oil pumps are responsible for circulating transmission fluid through the gearbox, cooling components, and lubricating critical parts of the transmission system. The oil helps to reduce heat buildup, which could otherwise lead to severe wear or failure. These pumps are typically powered by an electric motor, making them energy efficient compared to traditional mechanical pumps driven by the engine. In modern electric vehicles and hybrid systems, where minimizing energy consumption is vital, electric transmission oil pumps are essential.

To ensure that the electric transmission oil pump is functioning optimally, various sensors are integrated into the system. These sensors provide real-time data to the vehicle's control unit. One such sensor that is typically employed in the electric transmission oil pump is a negative temperature coefficient (NTC) sensor coupled to a printed circuit board (PCB) thereof. The inclusion of the NTC sensor on the PCB necessitates a new interface, which significantly complicates the design. Additional components and thermal paste between the NTC sensor and a plastic housing are required, as well as the increased complexity of routing the NTC sensor from the PCB to the plastic housing. As a result, this approach not only adds complexity but also decreases reliability. The NTC sensor is not in direct contact with the oil, which can lead to inaccurate temperature readings and may complicate an estimation process. As such, convention electric transmission oil pumps integrate additional circuitry to accommodate the NTC sensor's output and implement signal conditioning to ensure accurate temperature readings.

The added complexity of using the NTC sensor also requires extensive testing and validation to guarantee reliability, leading to increased production timelines and costs. Furthermore, establishing a robust interface between dry and wet cavities within the electric transmission oil pump introduces challenges related to sealing, thermal management, and potential interference, ultimately driving up the overall cost.

Accordingly, a system and method that uses machine learning to predict a fluid temperature within an electric pump, which reduces costs and design complexity while improving an accuracy of the predicted temperature.

### SUMMARY

In concordance and agreement with the presently described subject matter, a system and method that uses machine learning to predict a fluid temperature within an electric pump, which reduces costs and design complexity while improving an accuracy of the predicted temperature, have been newly designed. Shortcomings of the prior art are overcome and additional advantages are provided through the systems and the methods in accordance with the present disclosure.

In one embodiments, a system for predicting a temperature of a fluid within an electric pump, the system comprises: a computing system including one or more processing devices in communication with one or more sensors via at least one communication network, the one or more sensors isolated from a fluid within an electric pump and configured to detect and/or measure one or more parameters associated with the electric pump, wherein the computing system executes computer-readable instructions, and wherein, upon execution of the computer-readable instructions, the computing system is configured to: receive, via the at least one communication network, input data comprising the one or more parameters detected and/or measured by the one or more sensors; and predict, via the at least one processing device, a temperature of the fluid within the electric pump using the input data and machine learning.

In another embodiment, a method of predicting a temperature of a fluid within an electric pump, comprises: providing a computing system including one or more processing devices in communication with one or more sensors via at least one communication network, the one or more sensors isolated from a fluid within an electric pump and configured to detect and/or measure one or more parameters associated with the electric pump, and wherein the computing system is configured to execute computer-readable instructions; receiving, via the at least one communication network, input data comprising the one or more parameters detected and/or measured by the one or more sensors; and predict, via the at least one processing device, a temperature of the fluid within the electric pump using the input data and machine learning.

As aspects of some embodiments, upon execution of the computer-readable instructions, the computing system is further configured to compare, via the one or more processing devices, the input data to one or more threshold values.

As aspects of some embodiments, upon execution of the computer-readable instructions, the computing system is further configured to determine, via the one or more processing devices, a machine learning algorithm based on the comparison of the input data to the one or more threshold values.

As aspects of some embodiments, the machine learning employs a linear regression model and/or a non-linear regression model.

As aspects of some embodiments, the machine learning employs a multiple linear regression model and/or a polynomial non-linear regression model.

As aspects of some embodiments, the machine learning employs a linear regression model when an actual speed of an electric motor of the electric pump is less than a threshold value.

As aspects of some embodiments, the machine learning employs a non-linear regression model when an actual speed an electric motor of the electric pump is equal to or greater than a threshold value.

As aspects of some embodiments, the one or more parameters includes a temperature (Tpcb) of a printed circuit board (PCB) of the electric pump.

As aspects of some embodiments, the one or more parameters includes a direct current (Idc) of an electric motor of the electric pump. As aspects of some embodiments, the one or more parameters includes a supply voltage (Vdc) or DC component of an electric motor of the electric pump.

As aspects of some embodiments, the one or more parameters includes a reference current (IqRef) of an electric motor of the electric pump.

As aspects of some embodiments, the one or more parameters includes a back-electromotive force (BEMF) of an electric motor of the electric pump.

As aspects of some embodiments, the one or more parameters includes a stator q-axis voltage (Vq) of an electric motor of the electric pump.

As aspects of some embodiments, the one or more parameters includes a commanded speed (Scmd) of an electric motor of the electric pump.

As aspects of some embodiments, the one or more parameters includes an actual speed (Sact) of an electric motor of the electric pump.

As aspects of some embodiments, upon execution of the computer-readable instructions, the computing system is further configured to apply a low pass filter with a calculated cutoff frequency to the predicted temperature of the fluid within the electric pump.

As aspects of some embodiments, the low pass filter with the calculated cutoff frequency is applied when a period of time has elapsed and a moving average of the predicted temperature of the fluid within the electric pump has been calculated. As aspects of some embodiments, upon execution of the computer-readable instructions, the computing system is further configured to output, via the computing system, a last valid fluid temperature record fault when the predicted temperature of the fluid within the electric pump is outside of a predetermined range.

As aspects of some embodiments, upon execution of the computer-readable instructions, the computing system is further configured to output, via the computing system, a fluid temperature out of range fault when a fault count of a last valid fluid temperature record fault is greater than a threshold value.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

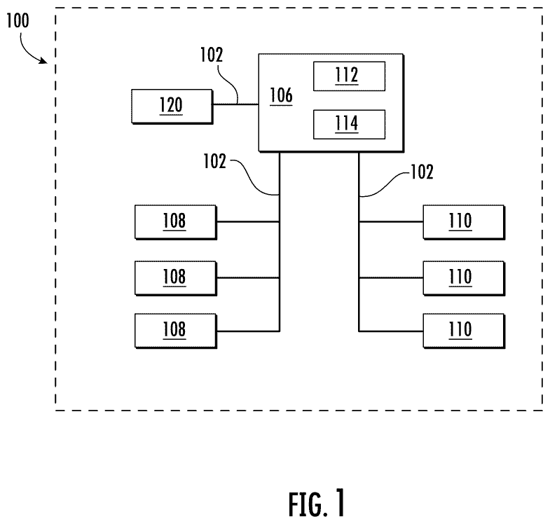

FIG. 1 is a schematic block diagram illustrating a system and environment for implementing a method for predicting a fluid temperature in accordance with an embodiment of the presently described subject matter;

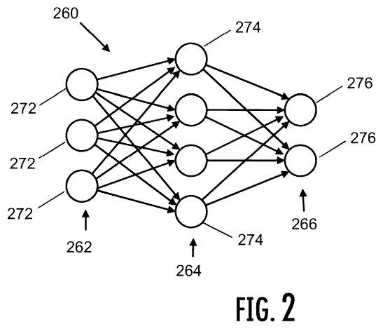

FIG. 2 is a diagram of a feedforward network, according to at least one embodiment, utilized in machine learning;

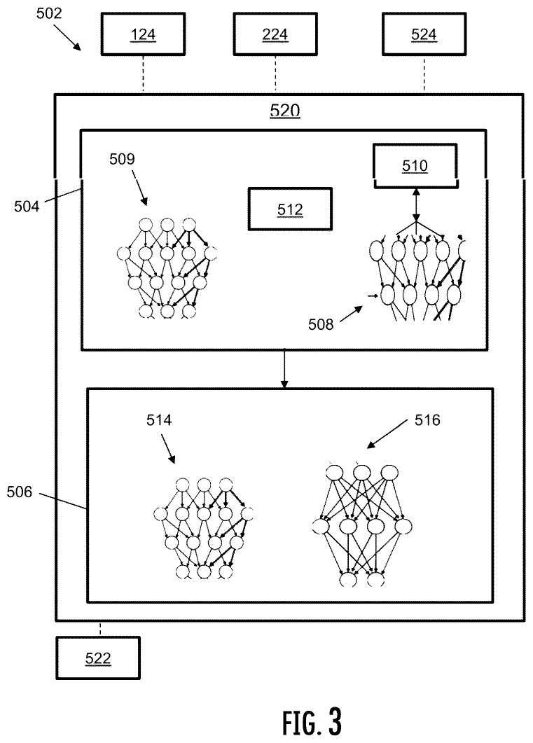

FIG. 3 is a schematic logic diagram of an artificial intelligence program including a front-end and a back-end algorithm;

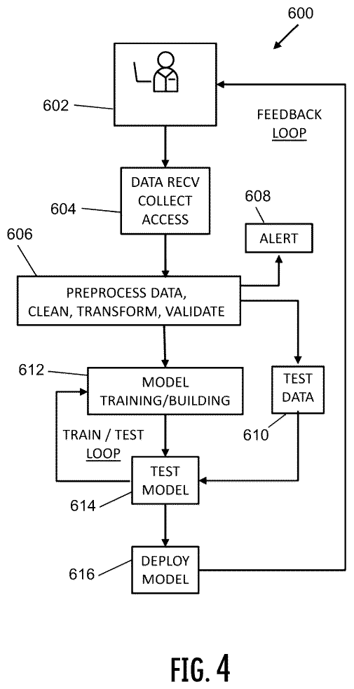

FIG. 4 is a flow diagram illustrating a method, according to at least one embodiment, of model development and deployment by machine learning;

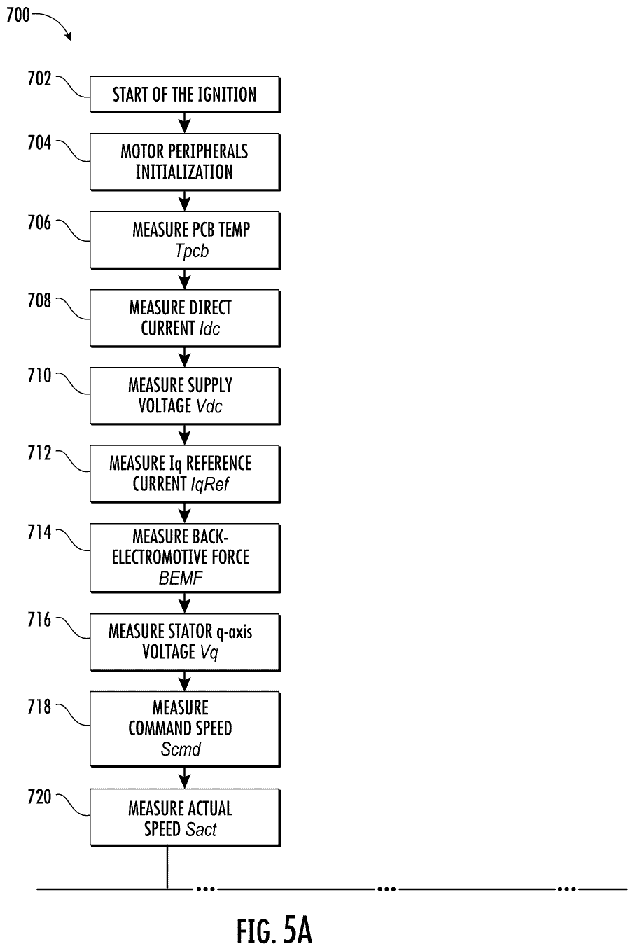

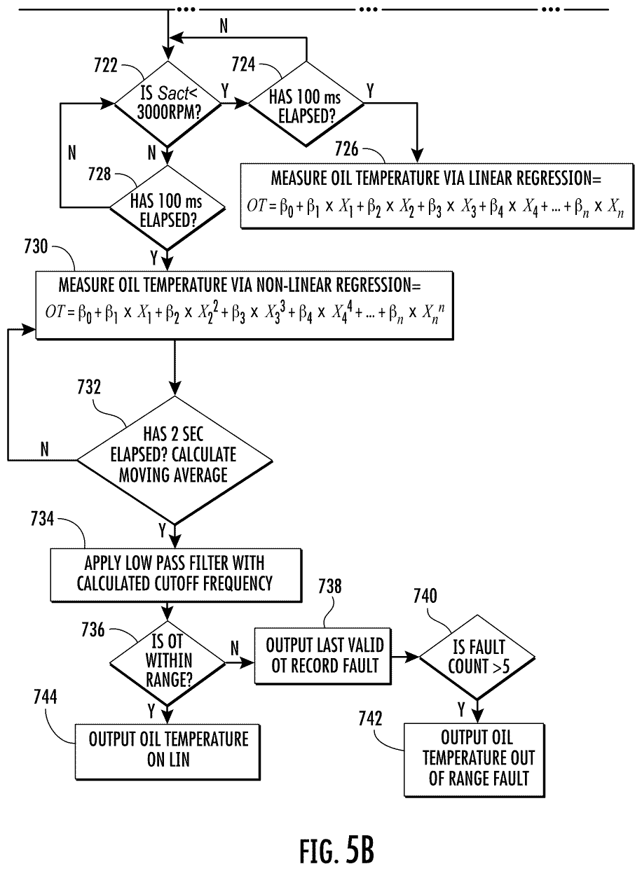

FIGS. 5A and 5B are a flow diagram illustrating an exemplary method of implementing at least one machine learning program for predicting a temperature of a fluid within an electric pump according to the presently described subject matter; and

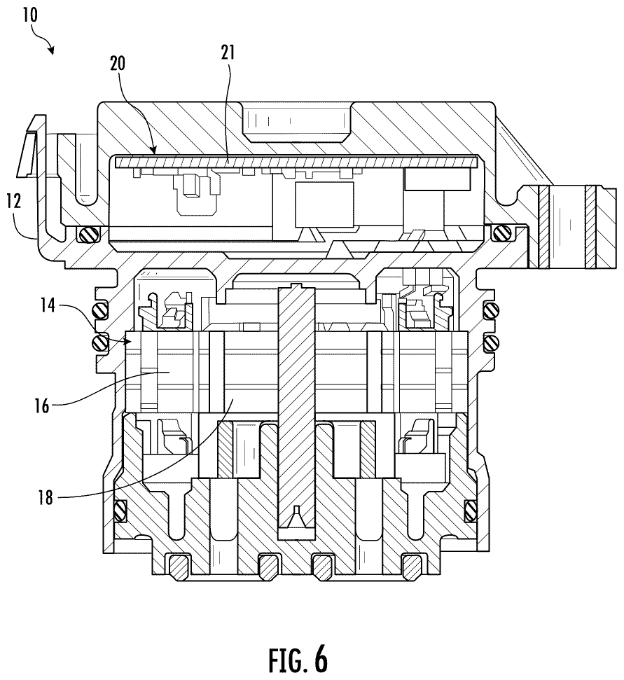

FIG. 6 is a cross-sectional view of an exemplary electric pump according to an embodiment of the presently described subject matter.

### DETAILED DESCRIPTION

Aspects of the present invention and certain features, advantages, and details thereof are explained more fully below with reference to the non-limiting examples illustrated in the accompanying drawings. Descriptions of well-known processing techniques, systems, components, etc. are omitted so as to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Like numbers refer to like elements throughout. Unless defined otherwise, technical and scientific terms used herein have the same meaning as commonly understood to one of ordinary skill in the art to which the presently disclosed subject matter pertains.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code can include both software and hardware. For example, program code in certain embodiments of the present invention can include fixed function hardware, while other embodiments can utilize a software-based implementation of the functionality described. Certain embodiments combine both types of program code.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Furthermore, a device or structure that is configured in a certain way is configured in at least that way, but may also be configured in ways that are not listed.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method, step of a method, device or element of a device that “comprises,” “has,” “includes,” or “contains,” or uses similar language to describe one or more steps or elements possesses those one or more steps or elements, but is not limited to possessing only those one or more steps or elements.

The terms “couple,” “coupled,” “connected,” and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

Embodiments of the present invention are described herein with reference to flowchart illustrations and/or block diagrams of computer-implemented method(s) and computing system(s). Each block or combinations of blocks of the flowchart illustrations and/or block diagrams can be implemented by computer readable program instructions or code that may be provided to a processor of a general purpose computer, special purpose computer, programmable data processing apparatus or apparatuses (the term “apparatus” includes systems and computer program products), and/or other device(s). In particular, the computer readable program instructions, which can be executed via the processor of the computer, programmable data processing apparatus, and/or other device(s), create a means for implementing the functions/acts specified in the flowchart and/or block diagram block(s).

In one embodiment, computer readable program instructions may also be stored in one or more computer-readable storage media that can direct a computer, programmable data processing apparatus, and/or other device(s) to function in a particular manner such that a computer readable storage medium of the one or more computer-readable storage media having instructions stored therein comprises an article of manufacture that includes the computer readable program instructions, which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block(s). Additionally or alternatively, these computer program instructions may be stored in a computer-readable memory that can direct a computer, programmable data processing apparatus, and/or other device(s) to function in a particular manner such that the instructions stored in the computer readable memory produce an article of manufacture that includes the computer readable program instructions, which implement the function/act specified in the flowchart and/or block diagram block(s). In some embodiments, computer-implemented steps/acts may be performed in combination with operator/human implemented steps/acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable computer readable program instructions for implementing the specified logical function(s). Similarly, alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, and/or the functions of the blocks may sometimes be executed in the reverse order, depending upon the functionality involved.

According to embodiments of the present disclosure a local interconnect network (LIN) and a controller area network (CAN), such as a data bus or “CAN bus”, each of which corresponds to a communication network in a vehicle, are briefly described hereinafter.

LIN communication corresponds to a communication scheme mainly used for data transmission among at least one electronic control unit (ECU) and one or more sensors. It typically connects less critical devices, such as sensors and actuators, to a central control unit, efficiently transmitting data with minimal resources. In some instances, LIN communication has a simple protocol structure, may be configured as a 12V single wire bus, and may operate based on a master-slave principle.

CAN communication is mainly used for data transmission between various ECUs of a vehicle system to facilitates efficient data exchange within the vehicle, enabling seamless integration and functionality of different components. In certain CAN communications, data may be transmitted through a CAN_H line and a CAN_L line coated to be shielded, and mutually twisted. CAN communication may operate based on a multi-master principle in which a plurality of ECUs perform master functions in a master/slave system. Oftentimes, the LIN complements CAN by handling lower-speed communications, typically managing non-critical functions.

FIG. 1 illustrates a block diagram of a system 100 in a vehicle according to an embodiment of the present invention. The system 100 may utilize one or more communication networks 102 (e.g., CAN, LIN, etc.), which allow communication between many vehicle systems and sub-systems, such as the vehicle engine, the transmission, braking system, etc. It is understood that any other suitable communication means, methods, and protocols may be utilized, such as Ethernet, for example. The present disclosure and teachings described herein provide for an electric pump 10 used in the vehicle systems. The electric pump 10 provides lubrication, cooling and pressure in various system configurations. The electric pump 10 may be configured to circulate a fluid (e.g., oil) through one or more vehicle systems such as a transmission system, for example. As illustrated in FIG. 6, the electric pump 10 may include a pump housing 12, an electric motor 14 comprising a stator 16 and a rotor 18, and an electrical controller 20 comprising a printed circuit board (PCB) 21 and an appropriate electrical connector (not depicted) for electrically coupling the electric machine 14 to a source of electrical current power (such as a battery or similar type device).

Referring back to FIG. 1, the system 100 includes a controller or computing system 106 in communication with one or more ECUs 108 and/or one or more sensors 110 via the communication networks 102. The computing system 106 may include at least one processing device 112 and at least one memory device 114 for storing computer-readable instructions and may be configured to receive input data (i.e., signals representative of sensed parameters) from the one or more sensors 110 located throughout the vehicle. In some embodiments, the computing system 106, including the at least one processing device 112 and the at least one memory device 114, may receive an input data from various sensors 110 associated with the electric pump 10, which are configured to detect and measure certain parameters thereof. In certain embodiments, the sensors 110 are isolated from the fluid within the electric pump 10 and are without contact thereof (i.e., none of the sensors 110 is a temperature sensor for the fluid). Preferably, the sensors 110 may be configured to detect and measure a temperature (Tpcb) of the PCB 21, a direct current (Idc) of the electric motor 14, a supply voltage (Vdc) of the electric motor 14, a reference current (IqRef) of the electric motor 14, a back-electromotive force (BEMF) of the electric motor 14, a stator q-axis voltage (Vq) of the electric motor 14, a commanded speed (Scmd) of the electric motor 14, and/or an actual speed (Sact) of the electric motor 14. A main controller or computing system 120 may be in communication with the computing system 106, one or more of the ECUs 108, and/or one or more of the sensors 110 via the communication networks 102.

In preferred embodiments, the computing device 106 may be further configured to predict a temperature of the fluid within the electric pump 10 using artificial intelligence and/or machine learning in accordance with the present disclosure.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. Additionally or alternatively, the machine learning algorithm may include one or more regression algorithms (e.g., linear and/or non-linear) configured to output a numerical value given an input. Further, the machine learning may include one or more pattern recognition algorithms, e.g., a module, subroutine or the like capable of translating text or string characters or subroutine. In various embodiments, the machine learning module may include a machine learning acceleration logic, e.g., a fixed function matrix multiplication logic, in order to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

An artificial neural network (ANN), also known as a feedforward network, may be utilized, e.g., an acyclic graph with nodes arranged in layers. A feedforward network (see, e.g., feedforward network 260 referenced in FIG. 2) may include a topography with a hidden layer 264 between an input layer 262 and an output layer 266. The input layer 262, having nodes commonly referenced in FIG. 2 as input nodes 272 for convenience, communicates input data, variables, matrices, or the like to the hidden layer 264, having nodes 274. The hidden layer 264 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 272 of the input layer, which then communicates the data to the hidden layer 264. The hidden layer 264 may be configured to determine the state of the nodes in the respective layers and assign weight coefficients or parameters of the nodes based on the edges separating each of the layers, e.g., an activation function implemented between the input data communicated from the input layer 262 and the output data communicated to the nodes 276 of the output layer 266. It should be appreciated that the form of the output from the neural network may generally depend on the type of model represented by the algorithm. Although the feedforward network 260 of FIG. 2 expressly includes a single hidden layer 264, other embodiments of feedforward networks within the scope of the descriptions can include any number of hidden layers. The hidden layers are intermediate the input and output layers and are generally where all or most of the computation is done.

Referring now to FIG. 3 and some embodiments, an AI program 502 may include a front-end algorithm 504 and a back-end algorithm 506. The artificial intelligence program 502 may be implemented on an AI processing device 520, such as the processing device 120, the processing device 220, and/or a dedicated processing device. The instructions associated with the front-end algorithm 504 and the back-end algorithm 506 may be stored in an associated memory device and/or storage device of the system communicatively coupled to the AI processing device 520, as shown. Additionally or alternatively, the system may include one or more memory devices and/or storage devices (represented by memory and/or storage devices 124, 224, 524 in FIG. 3) for processing use and/or including one or more instructions necessary for operation of the AI program 502. In some embodiments, the AI program 502 may include a deep neural network (e.g., a front-end network 504 configured to perform pre-processing, such as feature recognition, and a back-end network 506 configured to perform an operation on the data set communicated directly or indirectly to the back-end network 506). For instance, the front-end program 506 can include at least one CNN 508 communicatively coupled to send output data to the back-end network 506.

In some embodiments, the AI program 502 may be accelerated via a machine learning framework 520 (e.g., hardware). The machine learning framework may include an index of basic operations, subroutines, and the like (primitives) typically implemented by AI and/or machine learning algorithms. Thus, the AI program 502 may be configured to utilize the primitives of the framework 520 to perform some or all of the calculations required by the AI program 502. Primitives suitable for inclusion in the machine learning framework 520 include operations associated with training a convolutional neural network (e.g., pools), tensor convolutions, activation functions, basic algebraic subroutines and programs (e.g., matrix operations, vector operations), numerical method subroutines and programs, and the like.

FIG. 4 is a flow chart representing a method 600, according to at least one embodiment, of model development and deployment by machine learning. The method 600 represents at least one example of a machine learning workflow in which steps are implemented in a machine learning project.

In step 602, the machine-learning workflow is initiated. This may represent requesting machine-learning assistance or AI functionality to simulate intelligent behavior (such as a virtual agent) or other machine-assisted or computerized tasks that may, for example, entail decision-making, translation, forecasting, predictive modelling, and/or suggestions as non-limiting examples. In a first iteration from the user perspective, step 602 can represent a starting point. However, with regard to continuing or improving an ongoing machine learning workflow, step 602 can represent an opportunity for further user input or oversight via a feedback loop.

In step 604, data is received, collected, accessed, or otherwise acquired and entered as can be termed data ingestion. In step 606 the data ingested in step 604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing step 606 is updated with newly ingested data, an updated model will be generated. Step 606 can include data validation, which focuses on confirming that the statistics of the ingested data are as expected, such as that data values are within expected numerical ranges, that data sets are within any expected or required categories, and that data comply with any needed distributions such as within those categories. Step 606 can proceed to step 608 to automatically alert the initiating user, other human or virtual agents, and/or other systems, if any anomalies are detected in the data, thereby pausing or terminating the process flow until corrective action is taken.

In step 610, training test data such as a target variable value is inserted into an iterative training and testing loop. In step 612, model training, a core step of the machine learning work flow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training, in step 612, may be conducted with updated weights in the calculations.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which decision-making, translation, forecasting, predictive modelling, and/or automated suggestion generation serve as non-limiting examples.

FIGS. 5A and 5B illustrate a method 700 of predicting the temperature of the fluid within the electric pump 10 according to the present disclosure. In particular, the method 700 uses machine learning and the parameters of the electric pump 10 received from the sensors 110 to predict the temperature of the fluid within the electric pump 10.

Referring to FIG. 5A, the method 700 commences at a start of ignition of the vehicle at step 702 and where, upon execution of the computer-readable instructions, the computing device is configured to perform the method 700 described herein. At step 704, peripherals of the electric motor 20 are initialized. Thereafter, at step 706, one or more of the sensors 110 detects and measures the temperature (Tpcb) of the PCB 21. At step 708, one or more of the sensors 110 detects and measures the direct current (Idc) of the electric motor 14. At step 710, one or more of the sensors 110 detects and measures the supply voltage (Vdc) or DC component of the electric motor 14. At step 712, one or more of the sensors 110 detects and measures the reference current (IqRef) of the electric motor 14, At step 714, one or more of the sensors 110 detects and measures the back-electromotive force (BEMF) of the electric motor 14. At step 716, one or more of the sensors 110 detects and measures the stator q-axis voltage (Vq) of the electric motor 14. At step 718, one or more of the sensors 110 detects and measures the commanded speed (Scmd) of the electric motor 14. At step 720, one or more of the sensors 110 detects and measures the actual speed (Sact) of the electric motor 14. Each of the parameters detected and measured by the one or more sensors 110 (also referred to herein as “input data”) is transmitted to and received by the computing system 106, where the one or more of the parameters are processed by the at least one processing device 112. For example, the at least one processing device 112 executes the computer-readable instructions to compare the parameters received from the one or more of the sensors 110 to one or more predetermined threshold values.

Referring now to FIG. 5B, at step 722, when the actual speed (Sact) of the electric motor 14 is less than a first threshold value, for example, 3000 revolutions per minute (RPM), and, at step 724, a period of time is equal to or greater than a second threshold value, for example, at least 100 milliseconds (ms) has elapsed, the method 700 at step 726 uses linear regression machine learning to predict the temperature of the fluid (e.g. oil temperature (OT)) within the electric pump 10. Using the linear regression machine learning algorithm, at step 726, the temperature of the fluid (e.g. OT) may be predicted according to the following equation:

OT=β₀+β₁×X₁+β₂×X₂+β₃×X₃+β₄×X₄+ . . . +βₙ×Xₙ
where,
   β₁, β₂, β₃, . . . βₙ: Weights of coefficient assigned to each input parameter;
   β₀: An intercept or constant term in the regression equation;
   X₁, X₂, X₃, . . . Xₙ: Independent input parameters such as V_{q}, V_{dc}, I_{q}, BEFM etc.
   N: Number of Independent Input Parameters

However, when the actual speed (Sact) of the electric motor 14 is less than the first threshold value at step 722, but the period of time is less than the second threshold value at step 724, the method 700 returns to step 722.

When the actual speed (Sact) of the electric motor 14 is equal to or greater than the first threshold value, for example, 3000 revolutions per minute (RPM), and, at step 728, a period of time is less than a third threshold value, for example, at least 100 milliseconds (ms) has not elapsed, the method 700 returns to step 722.

When the actual speed (Sact) of the electric motor 14 is equal to or greater than the first threshold value at step 722, and the period of time is equal to or greater than the third threshold value at step 728, for example, at least 100 milliseconds (ms) has elapsed, the method 700 at step 730 uses non-linear regression machine learning to predict the temperature of the fluid (e.g. oil temperature (OT)) within the electric pump 10. Using the non-linear regression machine learning algorithm, at step 730, the temperature of the fluid (e.g. OT) may be predicted according to the following equation:

OT=β₀+β₁×X₁+β₂×X₂²+β₃×X₃³+β₄×X₄⁴+ . . . +βₙ×Xₙⁿ
where,
   β₁, β₂, β₃, . . . βₙ: Weights of coefficient assigned to each input parameter;
   β₀: An intercept or constant term in the regression equation;
   X₁, X₂, X₃, . . . Xₙ: Independent input parameters such as V_{q}, V_{dc}, I_{q}, BEFM etc.
   n: number of independent input parameters
      Xᵢⁿ: Term in polynomial regression to model non-linear relationships.

At step 732, when a period of time is less than a fourth threshold value, for example, at least 2 seconds has not elapsed, the method 700 repeats step 730 to predict the temperature of the fluid within the electric pump 10 again.

When the period of time is equal to or greater than the fourth threshold value at step 732, for example, at least 2 seconds has elapsed, the method 700 calculates a moving average of the predicted temperatures of the fluid within the electric pump 10. Thereafter, at step 734, a low pass filter with a calculated cutoff frequency is applied.

When the predicted temperature of the fluid within the electric pump 10 is outside a predetermined range at step 736, a last valid fluid temperature (e.g. OT) record fault is outputted by the controller 102 at step 738. At step 740, when a fault count is greater than a fifth threshold value, for example, the fault count exceeds five faults, a fluid temperature (e.g. OT) out of range fault is outputted by the computing system 106 at step 742.

Alternatively, when the predicted temperature of the fluid within the electric pump 10 is within the predetermined range at step 736, the predicted temperature of the fluid within the electric pump 10 is outputted by the controller 106 through communications via the communication networks 102 at step 744. Although the method 700 depicted in FIGS. 5A and 5B uses LIN as the communication networks 102, it is understood CAN or other suitable communication networks or combination thereof may be used as desired. Thereafter, the main controller 120 may receive the predicted temperature of the fluid within the electric pump 10 and may determine a condition and/or operating state of the electric pump 10 based on the predicted temperature of the fluid.

Although the machine learning program of the method 700 utilized a combination of linear and non-linear regression, it is understood that other machine learning programs, models, and algorithms, for example, the machine learning programs, models, and algorithms depicted in FIGS. 2-4.

Effects of system 100 and the method 700 according to the present invention are described below.

First, unlike conventional systems that rely on physical sensors (e.g., NTCs) for temperature measurement within an electric pump, the embodiments of the present disclosure employ a sensor-less approach by utilizing a machine learning model to predict the temperature of the fluid within the electric pump without direct sensor contact, thereby reducing a number of and dependency on physical components.

Second, the embodiments of the present disclosure may utilize a hybrid machine learning model which includes a combination of linear and non-linear regression. This allows for more nuanced and accurate temperature predictions based on operational data, thereby providing a more adaptable solution compared to standard regression techniques.

Third, the embodiments of the present disclosure minimize manufacturing costs and simplify the overall system architecture by eliminating the need for an NTC sensor and the associated interface between dry and wet cavities within the electric pump. Thus, this design solves common issues of complexity found in existing technology.

Fourth, the machine learning model utilized in some embodiments of the present disclosure leverages real-time data, allowing for dynamic adjustments in temperature prediction, which is lacking in conventional methods that rely on static sensor readings within the electric pump.

Fifth, by eliminating potential points of failure associated with physical sensors, the embodiments of the present disclosure offer increased reliability and durability as well as address concerns prevalent in conventional systems where sensor malfunction can lead to inaccurate readings.

It should be appreciated the system and method according to the present disclosure provides for a novel design for increasing an overall performance, efficiency, and reliability of the electric pump 10, while reducing the costs of the components of the electric pump 10, and thereby the overall costs of the vehicle.

It should be appreciated that the machine learning program may instead rely on a predictive model generated during an unsupervised learning processes described herein without necessarily departing from the scope of the present invention. The present disclosure refers to the use of input data in executing the corresponding machine learning program. Such input data may refer to the parameters of the electric pump 10 detected and measured by one or more of the sensors 110. The input data may be accumulated using any known method so long as the input data is recorded in a form configured for use with the computing system 106 and the corresponding machine learning program executed thereon. The present invention may rely upon the computing system 106 receiving the input data associated with each sensed parameter in order to train the machine learning program and subsequently utilize the predictive model generated thereby. The data set comprising the input data sets of each of the sensed parameter may collectively be referred to as the training data set associated with the machine learning program. The training data set may be organized based on the methodology of the machine learning program utilized in finding relationships between the input data and the temperature of the fluid within the electric pump 10.

In some embodiments, the machine learning program may be configured to perform unsupervised learning where the training data set formed by the input data of the sensed parameters is unlabeled with respect to all entries. Each of the different data entries regarding a specific sensed parameter may therefore form an independent unlabeled input for performing the unsupervised learning of the machine learning program.

As used hereinafter, all input data of each sensed parameter that is utilized in training the machine learning program or performing a prediction via the predictive model generated by the machine learning program may alternatively be referred to as the input data profile of the corresponding sensed parameter at the time at which such data is utilized by the machine learning program. The input data profile of the sensed parameter accordingly is different each time the input data regarding the sensed parameter as utilized by the machine learning program changes, such as when certain entries indicate a change in value or a change in state or condition with respect to the input data set of the sensed parameters. The unsupervised training of the machine learning program includes repeatedly adding new data to the training data set regarding the sensed parameters. As more data regarding the sensed parameters is added to the training data set, additional relationships may be discovered within the structure of the data or refinements may be made with respect to already discovered relationships, thereby improving the predictive capabilities of the machine learning program. The training of the machine learning program results in the generation of a predictive model wherein the machine learning program is configured to predict a temperature of the fluid within the electric pump 10 which is expected to be associated with sensed parameters.

Operations of the methods, and combinations of operation in the methods, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of a system and executed by at least one processor in the system. Any such computer program instructions may be loaded onto a computer or other programmable system (for example, hardware) to produce a machine, such that the resulting computer or other programmable system embody means for implementing the operations specified in the method.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

From the foregoing description, one ordinarily skilled in the art can easily ascertain the essential characteristics of this invention and, without departing from the spirit and scope thereof, can make various changes and modifications to the invention to adapt it to various usages and conditions.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

It is to be noted that various terms used herein such as “Linux®,” “Windows®,” “macOS®,” “iOS®,” “Android®,” and the like may be subject to trademark rights in various jurisdictions throughout the world and are used here only in reference to the products or services properly denominated by the marks to the extent that such trademark rights may exist.

What is claimed is:

1. A system for predicting a temperature of a fluid within an electric pump, the system comprising:
a computing system including one or more processing devices in communication with one or more sensors via at least one communication network, the one or more sensors isolated from a fluid within an electric pump and configured to detect and/or measure one or more parameters associated with the electric pump, wherein the computing system executes computer-readable instructions, and wherein, upon execution of the computer-readable instructions, the computing system is configured to:
receive, via the at least one communication network, input data comprising the one or more parameters detected and/or measured by the one or more sensors; and
predict, via the at least one processing device, a temperature of the fluid within the electric pump using the input data and machine learning.

2. The system of claim 1, wherein, upon execution of the computer-readable instructions, the computing system is further configured to compare, via the one or more processing devices, the input data to one or more threshold values.

3. The system of claim 2, wherein, upon execution of the computer-readable instructions, the computing system is further configured to determine, via the one or more processing devices, a machine learning algorithm based on the comparison of the input data to the one or more threshold values.

4. The system of claim 1, wherein the machine learning employs a linear regression model and/or a non-linear regression model.

5. The system of claim 1, wherein the machine learning employs a multiple linear regression model and/or a polynomial non-linear regression model.

6. The system of claim 1, wherein the machine learning employs a linear regression model when an actual speed of an electric motor of the electric pump is less than a threshold value.

7. The system of claim 1, wherein the machine learning employs a non-linear regression model when an actual speed an electric motor of the electric pump is equal to or greater than a threshold value.

8. The system of claim 1, wherein the one or more parameters includes a temperature (Tpcb) of a printed circuit board (PCB) of the electric pump.

9. The system of claim 1, wherein the one or more parameters includes a direct current (Idc) of an electric motor of the electric pump.

10. The system of claim 1, wherein the one or more parameters includes a supply voltage (Vdc) or DC component of an electric motor of the electric pump.

11. The system of claim 1, wherein the one or more parameters includes a reference current (IqRef) of an electric motor of the electric pump.

12. The system of claim 1, wherein the one or more parameters includes a back-electromotive force (BEMF) of an electric motor of the electric pump.

13. The system of claim 1, wherein the one or more parameters includes a stator q-axis voltage (Vq) of an electric motor of the electric pump.

14. The system of claim 1, wherein the one or more parameters includes a commanded speed (Scmd) of an electric motor of the electric pump.

15. The system of claim 1, wherein the one or more parameters includes an actual speed (Sact) of an electric motor of the electric pump.

16. The system of claim 1, wherein, upon execution of the computer-readable instructions, the computing system is further configured to apply a low pass filter with a calculated cutoff frequency to the predicted temperature of the fluid within the electric pump.

17. The system of claim 16, wherein the low pass filter with the calculated cutoff frequency is applied when a period of time has elapsed and a moving average of the predicted temperature of the fluid within the electric pump has been calculated.

18. The system of claim 1, wherein, upon execution of the computer-readable instructions, the computing system is further configured to output, via the computing system, a last valid fluid temperature record fault when the predicted temperature of the fluid within the electric pump is outside of a predetermined range.

19. The system of claim 1, wherein, upon execution of the computer-readable instructions, the computing system is further configured to output, via the computing system, a fluid temperature out of range fault when a fault count of a last valid fluid temperature record fault is greater than a threshold value.

20. A method of predicting a temperature of a fluid within an electric pump, comprising:
providing a computing system including one or more processing devices in communication with one or more sensors via at least one communication network, the one or more sensors isolated from a fluid within an electric pump and configured to detect and/or measure one or more parameters associated with the electric pump, and wherein the computing system is configured to execute computer-readable instructions;
receiving, via the at least one communication network, input data comprising the one or more parameters detected and/or measured by the one or more sensors; and
predict, via the at least one processing device, a temperature of the fluid within the electric pump using the input data and machine learning.
